(19) United States
(12) Patent Application Publication
(10) Pub. No.: US 2026/0280910 A1
(43) Pub. Date: Sep. 17, 2026

(54) APPARATUS AND METHOD FOR SELECTING CONGRESS CHAIR IN BLOCKCHAIN DISTRIBUTED CONSENSUS

(71) Applicant: ELECTRONICS AND TELECOMMUNICATIONS RESEARCH INSTITUTE, Daejeon (KR)

(72) Inventors: Jin-Tae OH, Daejeon (KR); Young-Chang KIM, Daejeon (KR); Sung-Jin MOON, Daejeon (KR); Min-Jae SEO, Daejeon (KR); Jong-Choul YIM, Daejeon (KR)

(73) Assignee: ELECTRONICS AND TELECOMMUNICATIONS RESEARCH INSTITUTE, Daejeon (KR)

(21) Appl. No.: 19/330,411

(22) Filed: Sep. 16, 2025

(30) Foreign Application Priority Data
Mar. 14, 2025 (KR) 10-2025-0033491

(51) Int. Cl. H04L 9/00

(52) U.S. Cl. CPC H04L 9/50

(57) ABSTRACT

Disclosed herein is an apparatus and method for selecting a consensus congress chair in blockchain distributed consensus. The apparatus receives a consensus message from a consensus congress chair node for distributed consensus of a blockchain, proceeds with the distributed consensus based on response messages of participating nodes to the consensus message, determines a participating node that does not transmit the response message to be a faulty node, and selects a new consensus congress chair node based on the position values of the faulty node and normal nodes in a block.

### CROSS REFERENCE TO RELATED APPLICATION

This application claims the benefit of Korean Patent Application No. 10-2025-0033491, filed Mar. 14, 2025, which is hereby incorporated by reference in its entirety into this application.

### BACKGROUND OF THE INVENTION

### 1. Technical Field

The present disclosure relates generally to blockchain distributed consensus technology, and more particularly to technology for selecting a consensus congress chair in blockchain distributed consensus.

### 2. Description of the Related Art

In environments such as blockchain, a consensus congress is required to derive results through consensus among distributed nodes. In particular, when the number of participating nodes is large, consensus may be delegated to some nodes representing the participating nodes to reach an agreement more quickly. However, if the consensus congress is fixed, it violates decentralization, so technology for randomly forming a consensus congress for each block is required.

As a method for forming a consensus congress selected from distributed random nodes, there are methods in which nodes each perform a coin toss by themselves, after which a consensus congress is selected based thereon. As an example of these methods, a method of performing a coin toss using a verifiable random function (VRF) and proving the coin toss results in the consensus process has been proposed. Also, in the paper titled “Algorithm based on Byzantine agreement among decentralized agents (BADA)”, which is published on Oct. 20, 2020, and U.S. Patent Application Publications No. 2019-0327084, No. 2019-0379538, No. 2020-0403776, and No. 2023-0066169, a method of selecting a consensus congress based on a nonce chain and a method of generating a blockchain using the same are disclosed in detail. The technology disclosed in the above paper and patents enables the size of a consensus congress to be set depending on the number of participating nodes. Therefore, when the consensus congress is determined, it is possible to know the number of nodes corresponding to a majority or two-thirds, so a simple consensus algorithm such as Practical Byzantine Fault Tolerance (PBFT) may be used. However, this method also has the disadvantage of requiring a message delivery protocol to determine the consensus congress.

The message delivery protocol for determining a consensus congress involves sending and receiving messages for forming a consensus congress between nodes, which imposes a significant load on the network and system as the number of nodes participating in the blockchain increases.

Also, technology for forming a consensus congress with random nodes without exchanging messages about coin toss results has been proposed.

The technology for forming a consensus congress using a VRF and a nonce chain involves a process in which nodes each deliver a message for proving their coin toss results, so if any node shuts down during the consensus congress selection process, the node cannot deliver a message and thus may be excluded from the consensus congress.

In the case of the technology for forming a consensus congress without message exchange, it has the advantages of reducing message delivery costs and enabling fast consensus because a consensus congress may be formed without message exchange, but because there is no message exchange, faulty nodes may be included in the consensus congress, which may cause delays in reaching an agreement.

Meanwhile, U.S. Patent Application Publication No. US2018-0329783, titled “Method and system for Byzantine fault-tolerance replicating of data on a plurality of servers”, discloses a consensus method capable of overcoming Byzantine faults and a view change protocol for primary node fault tolerance.

### SUMMARY OF THE INVENTION

An object of the present disclosure is to improve performance by minimizing consensus delays caused by faulty nodes in a randomly selected distributed consensus congress.

Another object of the present disclosure is to minimize delays that may occur when a faulty node is selected for a consensus congress before the faulty node is removed from participating nodes by sharing information about the fault of the node with all nodes.

In order to accomplish the above objects, an apparatus for selecting a consensus congress chair in blockchain distributed consensus according to an embodiment of the present disclosure includes one or more processors and memory for storing at least one program executed by the one or processors, and the at least one program allows a chair node to determine a node identified as being disconnected from a network connection to be a faulty node in a distributed consensus process of the current block of a blockchain, sorts hash values inserted into a pass vote list, which is used for selecting a consensus congress chair node of a subsequent block, in ascending order (or descending order) in consideration of the faulty node, sets the smallest index, excluding the faulty node, in the pass vote list in which the hash values are sorted as a top index, selects the node at the corresponding index as a consensus congress chair node of the current block, records the index of the consensus congress chair node of the subsequent block in the current block, and delivers the current block to all participating nodes of the blockchain.

Here, the pass vote list may be generated using information about a previous block and a public vote identifier corresponding to each of nodes constituting the blockchain.

Here, the pass vote list may be generated in such a way that each of the nodes performs an operation corresponding to a success probability (p) for the nodes, including the corresponding node itself, based on public vote identifiers, and pass vote lists that the nodes constituting the blockchain generate for an identical block may be identical to each other.

Here, the public node identifiers are stored in a vote identifier list of all the nodes.

Here, the at least one program may determine nodes located at indices lower than the index of a normal node in the pass vote list to be faulty nodes, the pass vote list being generated by performing a hash operation on a combination of the header of the current block and a vote identifier list.

Here, the at least one program may obtain a pass vote list for selecting a consensus congress of a subsequent block by performing hash operations on combinations of the header value of the current block and public node identifiers of nodes stored in a vote identifier list and may determine nodes located at indices lower than the top index delivered through the block to be faulty nodes.

Here, the at least one program may adjust the faulty node to be placed further down the order in the consensus congress of the subsequent block by adding a preset value to the hash value of the faulty node stored in the pass vote list (e.g., a pass vote value acquired by setting the 33rd bit to 1 in addition to a 32-bit representation thereof) and may select the node at the top index as a new consensus congress chair node.

Here, the at least one program may allow the consensus congress chair node to select the node at the index at which the first normal node is located in the sorted pass vote list as a new consensus congress chair node.

Here, the at least one program may allow all the nodes to select an identical consensus congress chair node for the subsequent block based on the index of the normal node delivered by the current consensus congress chair node.

Here, when the new consensus congress chair node does not respond until a preset threshold time, the at least one program may select a consensus congress chair node from among remaining consensus congress member nodes.

Also, in order to accomplish the above objects, a method for selecting a consensus congress chair in blockchain distributed consensus, performed by an apparatus for selecting a consensus congress chair in blockchain distributed consensus, includes determining a node identified as being disconnected from a network connection with a consensus congress chair for distributed consensus of a predetermined current block of a blockchain to be a faulty node, sorting hash values inserted into a pass vote list, which is used for selecting a consensus congress chair node, in consideration of the faulty node, selecting a node at the top of the pass vote list in which the hash values are sorted as a consensus congress chair node of a subsequent block, recording the consensus congress chair node of the subsequent block in the current block, and delivering the current block to all participating nodes of the blockchain.

Here, the pass vote list may be generated using information about a previous block and a public vote identifier corresponding to each of nodes constituting the blockchain.

Here, the pass vote list may be generated in such a way that each of the nodes performs an operation corresponding to a success probability (p) for the nodes, including the corresponding node itself, based on public vote identifiers, and pass vote lists that the nodes constituting the blockchain generate for an identical block may be identical to each other.

Here, determining the node identified as being disconnected from a network connection with the consensus congress chair to be a faulty node may comprise determining nodes located at indices lower than the index of a normal node in the pass vote list to be faulty nodes, the pass vote list being generated by performing a hash operation on a combination of the header of the current block and public node identifiers stored in a vote identifier list.

Here, selecting the node at the top of the pass vote list may comprise adjusting the faulty node to be placed further down the order in a consensus congress in the block by adding a preset value to a pass vote value (hash value) of the faulty node; and selecting a node adjusted to be at the top as a new consensus congress chair node.

Here, selecting the node at the top of the pass vote list comprises selecting, by the consensus congress chair node, the node at the index at which the first normal node is located as a new consensus congress chair node.

Here, selecting the node at the top of the pass vote list may comprise, when the new consensus congress chair node does not respond until a preset threshold time, selecting a consensus congress chair node from among remaining consensus congress member nodes.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating an example of a process of generating a pass vote list from public vote identifiers according to an embodiment of the present disclosure;

FIG. 2 is a view illustrating an example of a distributed consensus method according to an embodiment of the present disclosure;

FIG. 3 is a view illustrating another example of a distributed consensus method according to an embodiment of the present disclosure;

FIG. 4 is a view illustrating a further example of a distributed consensus method according to an embodiment of the present disclosure;

FIG. 5 is a flowchart illustrating an example of a process of generating public vote identifiers from public node identifiers according to an embodiment of the present disclosure;

FIG. 6 is a view illustrating an example of the use of a pass vote list in a distributed consensus method according to an embodiment of the present disclosure;

FIG. 7 is a flowchart illustrating an example of a distributed consensus method according to an embodiment of the present disclosure;

FIG. 8 is a flowchart illustrating an example of a blockchain generation method according to an embodiment of the present disclosure;

FIG. 9 is a flowchart illustrating a method for selecting a consensus congress chair in blockchain distributed consensus according to an embodiment of the present disclosure;

FIG. 10 is a view illustrating an ordered consensus congress including faulty nodes in a pass vote list according to an embodiment of the present disclosure;

FIG. 11 is a view illustrating a problem that may occur in the state in which nodes have inconsistent information about a faulty node in a pass vote list according to an embodiment of the present disclosure; and

FIG. 12 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are provided to fully describe the present disclosure to a person having ordinary knowledge in the art. Accordingly, the shapes, sizes, etc. of components in the drawings may be exaggerated in order to make the description clearer.

Throughout the specification, when a part “includes” a component, which means that it may further include other components, rather than excluding other components, unless otherwise specified.

Because the present disclosure may be variously changed and may have various embodiments, specific embodiments will be described in detail below with reference to the attached drawings.

However, it should be understood that those embodiments are not intended to limit the present disclosure to specific disclosure forms and that they include all changes, equivalents or modifications included in the spirit and scope of the present disclosure.

Various terms, such as “first”, “second”, “A”, “B”, “(a)”, “(b)”, etc., can be used to describe components of embodiments of the present disclosure. These terms merely differentiate one component from the other, but the substances, order, or sequence of the components are not limited by the terms.

Unless defined differently, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

In the present disclosure, it will be understood that when a component is referred to as being “connected” or “coupled” to another component, it can be directly connected or coupled to the other component, or intervening components may be present.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, components, or combinations thereof, but do not preclude the presence or addition of one or more other features, integers, steps, operations, components, or combinations thereof.

Hereinafter, preferred embodiments of the present disclosure will be described in detail with reference to the accompanying drawings. In the following description of the present disclosure, independent reference numerals are used for components that may be the same in the drawings, in order to facilitate an overall understanding.

In conventional technology, it is impossible to know the number of nodes to be selected as consensus congress candidates before a chair node receives messages about whether other nodes are selected for a consensus congress in the process of forming a consensus congress. Therefore, in order to form a consensus congress, the chair node according to the conventional technology sets a threshold time and waits until 3f+1 nodes respond (f being a Byzantine size and an integer equal to or greater than 1), and an exception handling process is required to handle the case in which the number of nodes constituting the consensus congress is less than 3f+1 when the threshold time expires. However, according to the present disclosure, all nodes can know the number of nodes that have succeeded in a coin toss operation and information about the chair node and the nodes constituting a consensus congress, so consensus may proceed immediately without the exchange of messages related to consensus congress formation.

It may be assumed that participating nodes in a blockchain are connected to a network in order to initiate block consensus. Here, the nodes typically use public key-based cryptography to ensure the integrity of delivered data, etc., and to this end, blockchain node x may generate a public key pkx from its private key skx and share its public key with other nodes connected to the network. Subsequently, node x may securely deliver data using its private key skx, and other nodes may use the public key pkx of node x to decrypt the delivered data and authenticate the source of the data. Here, the public key of each of the blockchain nodes may be an example of a public node identifier according to an embodiment of the present disclosure. That is, in an embodiment of the present disclosure, a public node identifier is information disclosed to other nodes and may be information for identifying a specific node. Here, the public node identifier may be the identifier of a specific node that is known or knowable to other nodes. Here, the public node identifier may be shared from the corresponding node to other nodes and may be delivered through information included in a message transmitted from the corresponding node to other nodes. For example, the public node identifier may be a serial number assigned to each of the blockchain nodes. For example, the public node identifier may be the public key itself of each of the blockchain nodes or identification information generated based on the public key.

As described in detail in the aforementioned U.S. Patent Application Publication No. 2023-0066169, blockchain nodes may have a number of votes corresponding to their shares. In the present disclosure, blockchain nodes may also have more than one vote, and a consensus congress may be selected based on results of an operation corresponding to a success probability of p, which is performed a number of times corresponding to the number of votes. For example, if a specific node has two votes and if the operation corresponding to the success probability, p, succeeds for at least one of the two votes, the specific node may be eligible to become a consensus congress candidate.

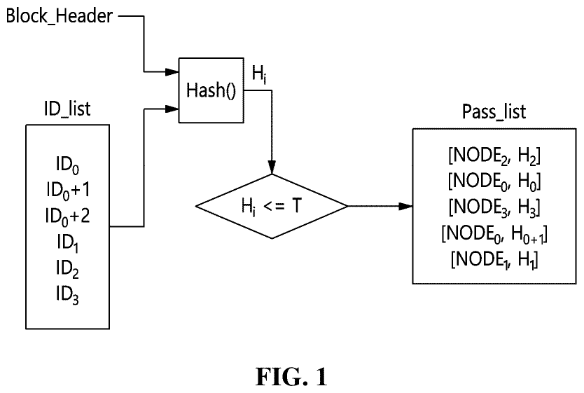

FIG. 1 is a view illustrating an example of a process of generating a pass vote list from public vote identifiers according to an embodiment of the present disclosure.

Referring to FIG. 1, it can be seen that a pass vote list (pass_list) is generated using a vote identifier list (ID_list) in which public vote identifiers are stored.

A public vote identifier may be an identifier corresponding to each vote (or a coin toss) and may be generated from a public node identifier. Here, a number of public vote identifiers corresponding to the number of votes of each of the nodes participating in the blockchain may be generated for the node using the public node identifier of the node. For example, if node A has 10 shares and therefore has 10 votes, 10 public vote identifiers for node A may be generated based on the public node identifier of node A. For example, if node B has two shares and therefore has two votes, two public vote identifiers for node B may be generated based on the public node identifier of node B.

The vote identifier list (ID_list) illustrated in FIG. 1 stores public vote identifiers when four nodes participate in the blockchain. In the example in FIG. 1, each of the four nodes may have its unique public node identifier. Here, the public node identifier of the first node may be ID₀, the public node identifier of the second node may be ID₁, the public node identifier of the third node may be ID₂, and the public node identifier of the fourth node may be ID₃. Here, the public node identifiers ID₀, ID₁, ID₂, and ID₃ may be the public keys of the respective nodes.

In the example in FIG. 1, the first node may have three votes, the second node may have one vote, the third node may have one vote, and the fourth node may have one vote. That is, in the example illustrated in FIG. 1, the total number of votes is 6.

The first node delivers its public node identifier (e.g., public key pk₀) and the fact that it has three votes to the remaining nodes. Each of the remaining nodes that receive this data may compute the three public vote identifiers (ID₀, ID₀+1, and ID₀+2) of the first node, and the computed three public vote identifiers of the first node may be stored in the vote identifier list (ID_list). The remaining nodes also deliver their public node identifiers and the number of votes owned thereby to other nodes in the same manner, so each of the nodes participating in the blockchain may generate the vote identifier list (ID_list) illustrated in FIG. 1.

In the example illustrated in FIG. 1, when the four nodes have a total of six votes, these nodes exchange information about their votes with each other and individually generate a vote identifier list (ID_list) containing the six public vote identifiers.

Accordingly, a single public vote identifier may be generated for each of the second, third, and fourth nodes, and three public vote identifiers may be generated for the first node. Here, one of the three public vote identifiers (ID₀) for the first node may be set to be the same as the public node identifier (e.g., public key pk₀) of the first node. Here, another one of the three public vote identifiers (ID₀+1) for the first node may be set to a value acquired by adding 1 to the public node identifier of the first node. Here, the remaining one of the three public vote identifiers (ID₀+2) for the first node may be set to a value acquired by adding 2 to the public node identifier of the first node. Particularly, when a public key is used as a public node identifier, the possibility of duplication of public vote identifiers generated by adding 1, 2, and so forth to the public node identifier in this manner is nearly zero. That is, the public vote identifiers (ID₀+1 and ID₀+2) are acquired by adding arbitrary values to the public key of a node, and because it is almost impossible to find a private key corresponding thereto, the public vote identifiers may be regarded as arbitrary data. As described above, the vote identifier list (ID_list) may store the public keys of the nodes and arbitrary data in a number corresponding to the total number of votes.

Here, the public vote identifier (ID₁) for the second node may be set to be the same as the public node identifier (e.g., public key pk₁) of the second node. Here, the public vote identifier (ID₂) for the third node may be set to be the same as the public node identifier (e.g., public key pk₂) of the third node. Here, the public vote identifier (ID₃) for the fourth node may be set to be the same as the public node identifier (e.g., public key pk₃) of the fourth node.

As a result, a total of six public vote identifiers (ID₀, ID₀+1, ID₀+2, ID₁, ID₂, and ID₃) for the four nodes may be stored in the vote identifier list, as illustrated in FIG. 1, and because this vote identifier list is generated based on the public node identifiers that are publicly available, it may be generated independently by each of the nodes participating in the blockchain. The generated public vote identifiers may match with the votes in a one-to-one manner.

In the example in FIG. 1, when multiple public vote identifiers are generated from a single public node identifier, the method of increasing the public node identifier by a preset number (e.g., 1) is used (after the first public vote identifier is set to the public node identifier), but various other methods may also be used to generate multiple public vote identifiers from a single public node identifier. Particularly, when generating multiple public vote identifiers from a single public node identifier, it is desirable to use a method that minimizes the possibility of duplicate public vote identifiers being generated.

In other words, according to an embodiment of the present disclosure, each of the nodes participating in the blockchain may disclose its public node identifier (e.g., public key) and the number of votes owned thereby to other nodes. Accordingly, each of the nodes participating in the blockchain can know the public node identifiers and the number of votes of all the nodes participating in the blockchain, including the node itself, and thus may generate the vote identifier list (ID_list) illustrated in FIG. 1. Here, the public vote identifiers included in the vote identifier list (ID_list) may correspond to the respective votes.

In the example illustrated in FIG. 1, when a block to be added to the blockchain is input, the data stored in the vote identifier list (ID_list) is extracted, and a pass vote list (pass_list) may be generated. That is, the pass vote list (pass_list) according to an embodiment of the present disclosure may be generated after completion of a consensus block and may be maintained only for the corresponding block.

In the blockchain consensus process, a consensus block is completed and stored in a committed message and may then be propagated to all nodes. That is, the chair may propagate the block completed at the commit phase to all nodes at the committed phase during the blockchain consensus process. Accordingly, at the time the consensus block is completed, each node in the blockchain may have already generated a vote identifier list (ID_list), and when each node receives the committed message through which the completed consensus block is propagated to all nodes, the node performs an operation corresponding to the success probability (p) by using the header value (Block_Header) of the completed block, thereby generating a pass vote list (Pass_list).

That is, the nodes that receive the block extract the header value (Block_Header) of the block and perform the operation corresponding to the success probability (p) using the header value along with the public vote identifiers within the vote identifier list (ID_list) generated as shown in FIG. 1, thereby generating a pass vote list (Pass_list).

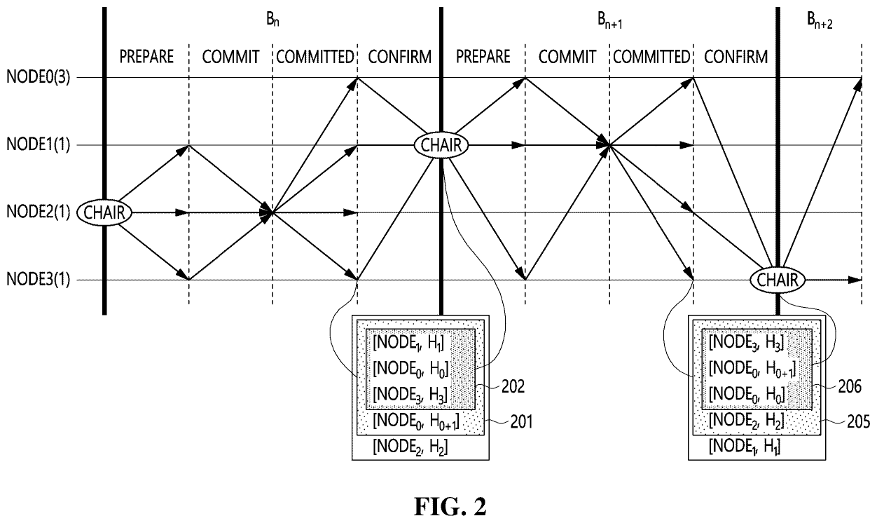

In the example illustrated in FIG. 1, Hash( ) is a hash function that receives the header value (Block_Header) of the block and the public vote identifier as input, and Hᵢ (i being a vote identifier) is a random value generated through the hash function. Here, Hᵢ may be computed by performing the hash operation on each of the public vote identifiers taken from the vote identifier list (ID_list) and the header value (Block_Header) of the block. Here, Hᵢ may be represented as Hash(Header_Bₙ, IDᵢ). Here, Header_Bₙ may indicate Block_Header corresponding to the block (Bₙ) illustrated in FIG. 2, and IDᵢ may indicate the public vote identifier corresponding to index i.

Here, the hash function may be SHA256 or the like. Here, the random value (Hᵢ) generated to correspond to the public vote identifier (IDᵢ) may be a value acquired by extracting only some bits from the output of the hash function. For example, the random value (Hᵢ) may be a value corresponding to part of 256 bits [255:0] output from the SHA256 function (e.g., the lower 32 bits [31:0]).

That is, random values (Hᵢ) corresponding to the respective votes are generated, and among the generated random values, only values that are not greater than a preset threshold T may be stored in the pass vote list (Pass_list) in the form of [node number, Hᵢ] pairs.

Here, an arbitrary value may be used as the threshold T. However, as described in the aforementioned U.S. Patent Application Publication No. 2023-0066169, etc., the success probability (p) of a vote (coin toss) of each node and the size of a consensus congress (3f+1) are computed by applying Equations (1) and (2) below, after which the threshold T satisfying the success probability p of the coin toss may be computed in consideration of the maximum value of the random value (Hᵢ).

$$1 - {\sum }_{k = 0}^{f} ( \begin{matrix}b \\ k\end{matrix} ) {{p}^{k} ( 1 - p )}^{( b - k )} \leq {P}_{max \_ bzt} \qquad ( 1 )$$

$${\sum }_{x = 0}^{3 f} ( \begin{matrix}n \\ x\end{matrix} ) {{p}^{x} ( 1 - p )}^{( n - x )} \leq {P}_{min \_ node} \qquad ( 2 )$$

Through the process (operation) of comparing the threshold T with the magnitude of the random value (Hᵢ), a coin toss with the success probability of p is implemented and performed for all random values (Hᵢ), and when the coin toss is successful, [node number, Hᵢ] pair is added to the pass vote list (Pass_list).

In the example illustrated in FIG. 1, it can be seen that only the random values corresponding to five of the six votes are included in the pass vote list (Pass_list). In other words, it can be seen that only the random values H₀ and H₀₊₁ corresponding to the two vote identifiers ID₀ and ID₀+1, among the three public vote identifiers ID₀, ID₀+1, and ID₀+2 for the first node, succeed in the operation (the random values do not exceed T as a result of comparison with the threshold) and the random value H₀₊₂ corresponding to the vote identifier ID₀+2 fails the operation (the random value exceeds T as a result of comparison with the threshold). The random values H₁, H₂, and H₃ corresponding to the public vote identifiers ID₁, ID₂, and ID₃ for the remaining nodes succeed in the operation (the random values do not exceed T as a result of comparison with the threshold), and it can be seen that a total of five random values H₀, H₀₊₁, H₁, H₂, and H₃ are stored in the pass vote list (Pass_list) along with the corresponding node numbers.

In other words, the pass vote list (Pass_list) in the example in FIG. 1 stores only the results that succeed in the operation (the random values that do not exceed T as the result of comparison with the threshold). Accordingly, two results including [NODE₀, H₀] and [NODE₀, H₀₊₁], which are the results of the operations using the public vote identifier ID₀ and the public vote identifier ID₀+1 for the first node, are stored, [NODE₁, H₁], which is the result of the operation using the public vote identifier ID₁ for the second node, is stored, [NODE₂, H₂], which is the result of the operation using the public vote identifier ID₂ for the third node, is stored, and [NODE₃, H₃], which is the result of the operation using the public vote identifier ID₃ for the fourth node, is stored.

Here, the result values stored in the pass vote list (Pass_list) may be sorted in order of the magnitude of the random values. For example, the result values stored in the pass vote list (Pass_list) may be sorted in ascending order according to the magnitude of the random values. In the example illustrated in FIG. 1, it can be seen that the magnitude of the random values is H₂<H₀<H₃<H₀₊₁<H₁. Here, after the operations for all the public vote identifiers are completed, 3f+1 nodes selected from the pass vote list (Pass_list) in ascending order may be set as a consensus congress.

FIG. 2 is a view illustrating an example of a distributed consensus method according to an embodiment of the present disclosure.

Referring to FIG. 2, it can be seen that a total of four nodes (NODE0, NODE1, NODE2, and NODE3) participate in a blockchain and that the total number of votes is six (three for NODE0, one for NODE1, one for NODE2, and one for NODE3).

NODE2 is the chair node of consensus for block Bₙ, and it transmits a prepare message for consensus on block Bₙ to consensus committee nodes (NODE1, NODE2, and NODE3), completes the consensus block, Bₙ, by receiving commit messages from the consensus committee nodes (NODE1, NODE2, and NODE3), and transmits a committed message for propagating the completed consensus block, Bₙ, to all the nodes including NODE0, NODE1, NODE2, and NODE3.

Upon receiving the committed message for the completed consensus block (Bₙ), all the nodes including NODE0, NODE1, NODE2, and NODE3 may form a consensus congress for block Bₙ₊₁ using block information (Header_Bₙ) of the completed consensus block, Bₙ.

That is, NODE2, which is the chair node corresponding to the consensus block, Bₙ, propagates block Bₙ completed at the commit phase to all the nodes (NODE0, NODE1, NODE2, and NODE3) at the committed phase, as illustrated in FIG. 2.

The nodes that receive block Bₙ extract the header value of block Bₙ, generate random values by performing a hash operation on the extracted header value and each of the public vote identifiers included in the vote identifier list, and generate a pass vote list by comparing the random values with a preset threshold.

The pass vote list for block Bₙ₊₁ may be computed by all the nodes that received the committed message corresponding to block Bₙ, and information about the consensus congress members of the pass vote list needs to be maintained in order for all the nodes that receive the committed message corresponding to block Bₙ₊₁ to verify that the block is signed by valid signers. Here, the chair may need information on the consensus congress members of the pass vote list across all the phases of the consensus (confirm, prepare, commit, and committed phases) in order to form the consensus congress and the consensus committee. Each of the remaining nodes, excluding the chair, may need information on the consensus congress members of the pass vote list in order to identify the chair node and proceed with the consensus when it is a member of the consensus congress, and nodes that are not included in the consensus congress may need the information on the consensus congress members of the pass vote list in order to verify whether the committed block is signed by the nodes that belong to the consensus committee.

Here, the pass vote list for block Bₙ₊₁ may be generated only after the committed message corresponding to block Bₙ is received. Accordingly, a valid pass vote list is managed such that it is not maintained for an excessively long time, and the random value to be used for a coin toss (operation with a success probability of p) may be appropriately generated.

In the example illustrated in FIG. 2, the pass vote list for block Bₙ₊₁ may store [NODE₁, H₁], [NODE₀, H₀], [NODE₃, H₃], [NODE₀, H₀₊₁], and [NODE₂, H₂] in ascending order according to the magnitude of the random value Hᵢ. That is, in the example illustrated in FIG. 2, it can be seen that the magnitude of the random values is H₁<H₀<H₃<H₀₊₁<H₂. Also, in the example illustrated in FIG. 2, it can be seen that only the coin toss for the public vote identifier corresponding to the third vote of NODE0, among the six votes, fails and that the coin tosses for all the remaining public vote identifiers are successful.

Here, [NODE₁, H₁] may be the operation result corresponding to the random value H₁ computed based on a single public vote identifier of NODE1, [NODE₀, H₀] may be the operation result corresponding to the random value H₀ computed based on the first public vote identifier (e.g., the public key of NODE0) among the three public vote identifiers of NODE0, [NODE₃, H₃] may be the operation result corresponding to the random value H₃ computed based on a single public vote identifier of NODE3, [NODE₀, H₀₊₁] may be the operation result corresponding to the random value H₀₊₁ computed based on the second public vote identifier (e.g., the value acquired by adding 1 to the public key of NODE0) among the three public vote identifiers of NODE0, and [NODE₂, H₂] may be the operation result corresponding to the random value H₂ computed based on a single public vote identifier of NODE2. In the example in FIG. 2, it can be seen that the random value H₀₊₂ computed based on the third public vote identifier (e.g., the value acquired by adding 2 to the public key of NODE0), among the three public vote identifiers of NODE0, fails the threshold comparison (coin toss).

Here, the consensus congress 201 for block Bₙ₊₁ includes [NODE₁, H₁], [NODE₀, H₀], [NODE₃, H₃], and [NODE₀, H₀₊₁]. Here, because [NODE₁, H₁] corresponds to the smallest random value, NODE1 may become a chair node for the consensus on the next block (Bₙ₊₁), as illustrated in FIG. 2.

In the example in FIG. 2, the consensus for block Bₙ₊₁ is initiated, and NODE1, which is the chair node, selects [NODE₁, H₁], [NODE₀, H₀], and [NODE₃, H₃] as a consensus committee 202 and transmits a prepare message to the corresponding nodes, that is, NODE1, NODE0, and NODE3.

As described above, the existing technology does not allow each of votes by the shares of a node to be exercised by an individual consensus congress, but according to an embodiment of the present disclosure, when selecting a consensus congress, the votes for selecting a consensus congress may be exercised separately.

Consensus for block Bₙ₊₁ may be performed through a process in which the chair node (NODE1) receives commit messages from the nodes corresponding to the consensus committee (NODE0, NODE1, and NODE3) and transmit a committed message corresponding thereto to all nodes, as illustrated in FIG. 2.

Upon receiving the committed message corresponding to block Bₙ₊₁, all the nodes may generate a pass vote list corresponding to block Bₙ₊₂. In other words, each of the nodes that receive the committed message corresponding to block Bₙ₊₁ extracts the header value of block Bₙ₊₁, generates random values by performing a hash operation on the extracted header value and each of the public vote identifiers included in the vote identifier list, and compares the random values with a preset threshold, thereby generating a pass vote list for block Bₙ₊₂.

In the example illustrated in FIG. 2, the pass vote list for block Bₙ₊₂ may store [NODE₃, H₃], [NODE₀, H₀₊₁], [NODE₀, H₀], [NODE₂, H₂], and [NODE₁, H₁] in ascending order according to the magnitude of the random values Hᵢ. That is, in the example illustrated in FIG. 2, it can be seen that the magnitude of the random values generated for the consensus of block Bₙ₊₂ is H₃<H₀₊₁<H₀<H₂<H₁. Also, in the example illustrated in FIG. 2, it can be seen that only the coin toss for the public vote identifier corresponding to the third vote of NODE0, among the six votes, fails and that the coin tosses for all the remaining public vote identifiers are successful.

Here, [NODE₃, H₃] may be the operation result corresponding to the random value H₃ computed based on a single public vote identifier of NODE3, [NODE₀, H₀₊₁] may be the operation result corresponding to the random value H₀₊₁ computed based on the second public vote identifier (e.g., the value acquired by adding 1 to the public key of NODE0) among the three public vote identifiers of NODE0, [NODE₀, H₀] may be the operation result corresponding to the random value H₀ computed based on the first public vote identifier (e.g., the public key of NODE0) among the three public vote identifiers of NODE0, [NODE₂, H₂] may be the operation result corresponding to the random value H₂ computed based on a single public vote identifier of NODE2, and [NODE₁, H₁] may be the operation result corresponding to the random value H₁ computed based on a single public vote identifier of NODE1. In the example in FIG. 2, it can be seen that the random value H₀₊₂ computed based on the third public vote identifier (e.g., the value acquired by adding 2 to the public key of NODE0), among the three public vote identifiers of NODE0, fails the threshold comparison (coin toss) when a consensus congress for block Bₙ₊₂ is formed.

Here, the consensus congress 205 for block Bₙ₊₂ includes [NODE₃, H₃], [NODE₀, H₀₊₁], [NODE₀, H₀], and [NODE₂, H₂]. Here, because [NODE₃, H₃] corresponds to the smallest random value, NODE3 may become a chair node for the consensus of the next block (Bₙ₊₂), as illustrated in FIG. 2.

In the example in FIG. 2, the consensus for block Bₙ₊₂ is initiated, and NODE3, which is the chair node, selects [NODE₃, H₃], [NODE₀, H₀₊₁], and [NODE₀, H₀] as a consensus committee 206 and transmits a prepare message to the corresponding nodes (NODE3 and NODE0).

In the existing distributed consensus technologies, such as a distributed consensus method using a nonce chain, each node that succeeded in a coin toss is required to generate a message for proving the success of the coin toss and transmit the message to additional nodes. The additional nodes have no choice but to form a consensus congress after verifying that a specific node succeeded in the coin toss based on the message received from the corresponding node.

However, according to the present disclosure, all nodes may generate the same pass vote list for a specific block by utilizing the public node identifier assigned to each of the nodes, such as a public key, and thus easily identify the nodes to constitute a consensus congress without special messages for forming a consensus congress, whereby the consensus efficiency may be maximized.

That is, according to the present disclosure, distributed nodes connected to a blockchain may compute the composition of a consensus congress for the next block by themselves without receiving messages related to a new consensus congress from other nodes. The nodes participating in the consensus individually compute values required for selecting a consensus congress of the next block for each node based on the public vote identifiers of all the participating nodes and data extracted from the current block, thereby computing the consensus congress for the next block.

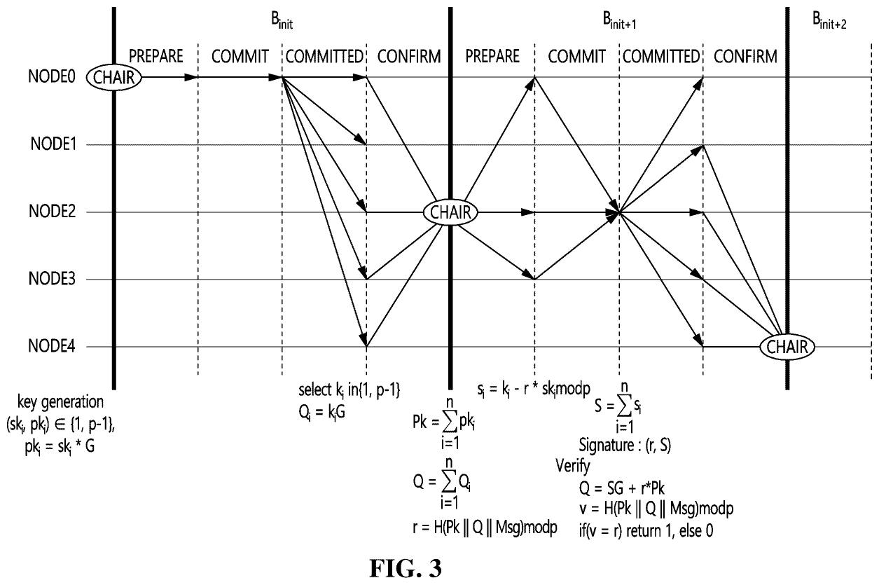

FIG. 3 is a view illustrating another example of a distributed consensus method according to an embodiment of the present disclosure.

Referring to FIG. 3, it can be seen that a total of five nodes including NODE0, NODE1, NODE2, NODE3, and NODE4 participate in a blockchain and that the total number of votes is five (one for each node). In other words, FIG. 3 shows the process in which, when all participating nodes have a share of 1, the participating nodes form a random consensus congress and reach an agreement without exchanging additional messages for forming a consensus congress.

The example in FIG. 3 may correspond to an initial block generation process after the participating nodes in the blockchain share public node identifiers and the number of their votes with each other. Here, the setup of a vote identifier list including public vote identifiers may have already been completed before the process illustrated in FIG. 3 is performed.

In the example illustrated in FIG. 3, a protocol for the initial block generation and consensus process is described on the assumption that all nodes have one vote each, for convenience of description, but each node may have multiple votes, as described above. When some nodes participate in a consensus congress with multiple votes, consensus may be made efficiently by delivering only a single message for consensus and using the vote count in the consensus committee for the consensus tally.

In the consensus process for an initial block (Binit), NODE0 that is arbitrarily selected as a chair for the consensus on the initial block generates the initial block by solely going through the prepare and commit phases and signing the block and then delivers the block to all the nodes, which are NODE0, NODE1, NODE2, NODE3, and NODE4.

As illustrated in FIG. 3, the consensus process includes four phases. In the consensus process for the initial block (Binit), only NODE0 participates in the consensus congress, so the prepare and commit phases may be performed inside NODE0. In this process, the initial block (Binit) is signed with the private key of NODE0, and the signed final block is delivered to all the nodes (NODE0, NODE1, NODE2, NODE3, and NODE4) at the committed phase. In the example in FIG. 3, EC-Schnorr multi-signature may be used for consensus. Multi-signature in the consensus process is disclosed in detail in the aforementioned U.S. Patent Application Publication No. 2020-0403776.

At the confirm phase, each node verifies the signature of the initial block (Binit), and if there is any problem, the consensus fails, and a re-consensus protocol proceeds. If there is no problem with the verification result, a pass vote list (Pass_list) is generated using the vote identifiers contained in the stored vote identifier list (ID_list) of the nodes and the header value of the initial block (Binit), as described above with reference to FIG. 1. As described above, all the nodes that receive the committed message may generate the pass vote list.

In the example in FIG. 3, it is assumed that each of the five nodes, including NODE0, NODE1, NODE2, NODE3, and NODE4, has one vote, so p and f satisfying Equations (1) and (2) above are 1.0 and 1, respectively. All [node number, Hᵢ] pairs that satisfy the threshold comparison condition are added to the pass vote list (Pass_list), and four nodes are selected in ascending order of Hᵢ to form a consensus congress. In the example in FIG. 3, all of the five votes pass the threshold comparison, so the five [node number, Hᵢ] pairs sorted in ascending order may be stored in the pass vote list (Pass_list). Here, among the stored values, the result values for four nodes corresponding to 3f+1, including NODE2, NODE0, NODE4, and NODE3, may be selected as corresponding to a consensus congress. Therefore, NODE2, NODE0, NODE4, and NODE3 become consensus congress nodes for consensus on the next block (Bᵢₙᵢₜ₊₁), and NODE2 corresponding to the smallest Hᵢ value becomes a chair node for block Bᵢₙᵢₜ₊₁.

FIG. 3 illustrates an example in which NODE2, NODE0, NODE4, and NODE3 are selected as a consensus congress and then consensus proceeds. This process may be performed by all distributed nodes, and because all nodes that confirm the same initial block (Bᵢₙᵢₜ) obtain the same operation (coin toss) results, these nodes may form the same consensus congress without exchanging messages for forming a consensus congress.

Referring to FIG. 3 again, each of the nodes selected as the consensus congress for the next block at the confirm phase, that is, NODE2, NODE0, NODE4, and NODE3, generates random kᵢ and generates Qᵢ on the elliptic curve. Each node included in the consensus congress delivers the checksum of the received block header and Qᵢ to NODE2, which is the chair node for the next block (Bᵢₙᵢₜ₊₁), to confirm the consensus result for the initial block (Bᵢₙᵢₜ) and prepare for consensus on the next block. Here, the checksum and Qᵢ are delivered along with the signature of node i to ensure integrity. Here, the nodes selected as the consensus congress deliver the pending transactions to the chair node such that the chair node can process the transactions.

NODE2, which is the chair for block Bᵢₙᵢₜ₊₁, randomly selects 2f+1 nodes from among the nodes that submitted the checksum and Qᵢ, checks whether the checksums of the selected nodes are the same as each other to confirm that the nodes have received the same block (Bᵢₙᵢₜ), and proceeds with consensus with these 2f+1 nodes. In the example illustrated in FIG. 3, NODE2, which is the chair for block Bᵢₙᵢₜ₊₁, selects three (2f+1) consensus committee nodes (NODE2, NODE0, and NODE3) from among the four (3f+1) consensus congress nodes (NODE2, NODE0, NODE4, and NODE3), confirms that the checksums of NODE2, NODE0, and NODE3 are the same, and proceeds with consensus together with NODE2, NODE0, and NODE3.

As shown in FIG. 3, the chair that initiated the initial block (Bᵢₙᵢₜ) is NODE0, but NODE2, which is the chair for the next block (Bᵢₙᵢₜ₊₁), may finally confirm the consensus result of the initial block (Bᵢₙᵢₜ).

At the prepare phase for block Bᵢₙᵢₜ₊₁, NODE2 generates a preliminary block that includes the transactions received from guests or the transactions that are received from nodes at the confirm phase of block Bᵢₙᵢₜ. Here, NODE2 may generate a prepare message (including a prepare block) by including Pk, Q, and r in the block, Pk being acquired by combining the public keys of NODE2, NODE0, and NODE3 and Q being acquired by combining Qᵢ thereof, and may deliver the prepare message to NODE2, NODE0, and NODE3. Each of the nodes (NODE2, NODE0, and NODE3) that receive the prepare message checks whether there is any anomaly in the block, and if no anomaly is found, it generates si signed with its private key and returns a commit message to the chair node (NODE2). Upon receiving all the commit messages, the chair node (NODE2) generates S by combining the values of sᵢ, completes a signature (r, S), and generates a committed block, and delivers the committed block to all nodes.

Each of the nodes that receive the committed block verifies the validity of the block by checking the public keys and signatures corresponding to the 2f+1 nodes of the consensus congress. If the block is valid as the result of checking, a subsequent pass vote list may be generated after computing Hᵢ using the header value of block Bᵢₙᵢₜ₊₁, and a consensus congress for block Bᵢₙᵢₜ₊₂ may be formed. In the example in FIG. 3, NODE4, NODE3, NODE1, and NODE2 constitute a consensus congress and transmit a confirm message to NODE4, which is a chair for block Bᵢₙᵢₜ₊₂. In other words, at the confirm phase for block Bᵢₙᵢₜ₊₁, NODE4, NODE3, NODE1, and NODE2 deliver the checksum and Qᵢ to NODE4 to complete the consensus for block Bᵢₙᵢₜ₊₁. Then, consensus on block Bᵢₙᵢₜ₊₂ may proceed through the same process as the above-described process for block Bᵢₙᵢₜ₊₁.

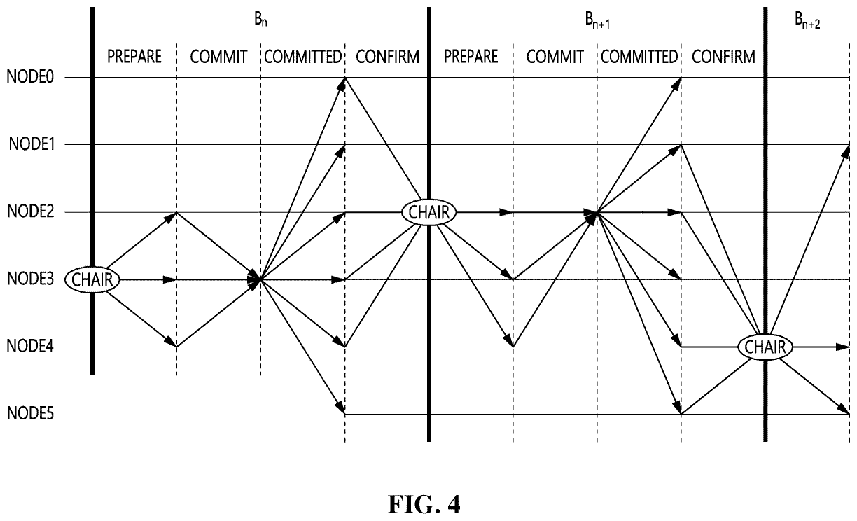

FIG. 4 is a view illustrating a further example of a distributed consensus method according to an embodiment of the present disclosure.

Referring to FIG. 4, it can be seen that NODE5 is added as a participating node in addition to existing five nodes, NODE0, NODE1, NODE2, NODE3, and NODE4.

That is, referring to FIG. 4, it can be seen that, when NODE5 is added as a participating node during the consensus time of block Bₙ, NODE5 may participate in the consensus congress normally from the consensus on block Bₙ₊₁ (node addition process).

In the example in FIG. 4, it is assumed that the intention of NODE5 to participate in consensus is delivered to NODE3, which is the chair for block Bₙ. NODE5 collects information about the nodes currently participating in consensus by accessing the network where the consensus is proceeding. After it receives information about the consensus nodes and public node identifiers (e.g., public keys), NODE5 generates a vote identifier list (ID_list) including public vote identifiers based thereon and delivers its intention to participate in consensus to other nodes. Each of the nodes that received information about the new participating node during the time corresponding to block Bₙ₋₁ may deliver the corresponding content to NODE3, which is the chair, during the time corresponding to block Bₙ. NODE3 may include the corresponding content in consensus transactions and proceed with consensus. Here, the block for which the commit phase is completed may include information about the new participating node. Therefore, when the commit phase is completed, the chair node (NODE3) may add the public vote identifier(s) of NODE5 to its vote identifier list (ID_list). The chair node (NODE3) may deliver the generated block to all nodes at the committed phase. All the nodes that receive the committed message add the public vote identifier(s) of the new node (NODE5) to their vote identifier list (ID_list). Accordingly, from the confirm phase of block Bₙ, nodes including NODE0, NODE1, NODE2, NODE3, NODE4, and NODE5 may participate in consensus.

In the process for consensus on block Bₙ₊₁, the chair node, NODE2, agrees on the new block through the prepare and commit phases and propagates the completed block to all nodes. In other words, a new node may participate in consensus through the process illustrated in FIG. 4.

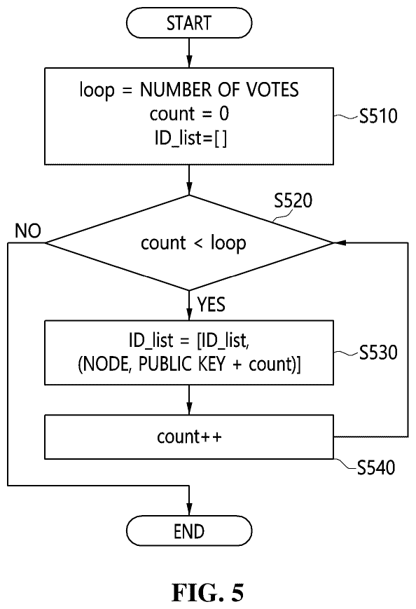

FIG. 5 is a flowchart illustrating an example of the process of generating public vote identifier(s) from a public node identifier according to an embodiment of the present disclosure.

Referring to FIG. 5, it can be seen that a public key is used as an example of the public node identifier of a node and public vote identifier(s) are generated based on the public key of the node and included in a vote identifier list (ID_list).

The steps illustrated in FIG. 5 show the process of generating one or more public vote identifiers for a specific node by utilizing the public node identifier of the specific node. The steps illustrated in FIG. 5 may be performed for each public node identifier. For a specific public node identifier (e.g., public key), a number of public vote identifiers corresponding to the number of votes of the corresponding node may be generated through the process illustrated in FIG. 5.

First, variables for generating public vote identifiers are initialized at step S510. That is, at step S510, the variable ‘loop’ is set to a value corresponding to the number of votes of a corresponding node, the variable ‘count’ is set to 0, and the vote identifier list (ID_list) is initialized.

Subsequently, the variable ‘count’ is compared with the variable ‘loop’ at step S520. When ‘count’ is less than ‘loop’ as the result of the comparison at step S520, a public vote identifier corresponding to a value acquired by adding the variable ‘count’ to the public key (public node identifier) of the corresponding node is added to the vote identifier list (ID_list) at step S530. As illustrated in FIG. 5, the vote identifier list (ID_list) may also store the node number along with the public vote identifier.

When the public vote identifier is added at step S530, the variable ‘count’ is incremented by 1 at step S540, and then the process goes back to step S520 to compare the variable ‘count’ with the variable ‘loop’.

When ‘count’ is not less than ‘loop’ as the result of the comparison at step S520, the process of generating the vote identifiers for the corresponding node is terminated.

Through the process illustrated in FIG. 5, a number of public vote identifiers (public key, public key+1, public key+2, . . . , public key+the number of votes−1) corresponding to the number of votes for a specific node may be generated.

In the example in FIG. 5, the case in which public vote identifier(s) are generated by adding a preset number to the public node identifier is illustrated, but various methods may be used to generate a number of public vote identifier(s) corresponding to the number of votes by utilizing the public node identifier.

Here, the public vote identifiers may be generated by a vote identifier generator (function). In the example illustrated in FIG. 5, the vote identifier generator may be a function that adds ‘count’ incrementing by 1 to the public node identifier (public key) input thereto.

The vote identifier generator (function) may be any of various types of functions that receive a public node identifier as input and output a number of public vote identifiers corresponding to the number of votes. Here, the vote identifier generator may include a duplication checker for checking whether the generated public vote identifiers are duplicated. Here, the duplication checker may check not only for duplication between the generated public vote identifier and other vote identifiers, but also for duplication between the generated public vote identifier and the public node identifiers of other nodes.

As described above, when a number of public vote identifiers corresponding to the number of votes of a single node are generated and a coin toss is performed using the public vote identifiers, parallel execution of coin tosses becomes possible, compared to the method of performing a subsequent coin toss by hashing a result of a previous coin toss at a specific node, thereby increasing the computation speed for selecting a consensus congress.

The public vote identifiers generated by the vote identifier generator may be unique identifiers that respectively correspond to the votes held by the node, and the number of bits for representing the public vote identifier may be the same as or different from the number of bits for representing the public node identifier.

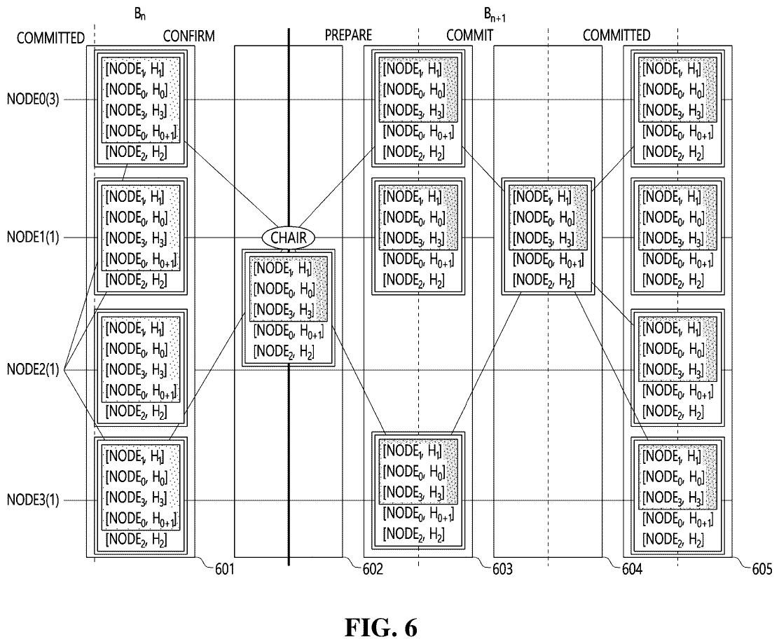

FIG. 6 is a view illustrating an example of the use of a pass vote list in a distributed consensus method according to an embodiment of the present disclosure.

Referring to FIG. 6, it can be seen that the pass vote lists 601 generated by the nodes (NODE0, NODE1, NODE2, and NODE3) that received the committed block of block Bₙ are the same as each other. Here, NODE0, NODE1, NODE2, and NODE3 may confirm that a chair is NODE1 and may check whether they are included in a consensus congress.

NODE0 may confirm that [NODE₁, H₁], [NODE₀, H₀], [NODE₃, H₃], and [NODE₀, H₀₊₁] are selected from the pass vote list for a consensus congress, confirm that the result value [NODE₀, H₀] corresponding to NODE0 itself is placed second on the pass vote list, and confirm that NODE0 itself is selected for the consensus congress. Here, NODE0 may recognize that NODE1 becomes a chair based on the first result value ([NODE₁, H₁]) on the pass vote list. In addition, NODE0 may confirm that the result value [NODE₀, H₀₊₁] corresponding to NODE0 itself is placed fourth on the pass vote list and confirm that it has two votes in the consensus congress.

NODE1 may confirm that [NODE₁, H₁], [NODE₀, H₀], [NODE₃, H₃], and [NODE₀, H₀₊₁] are selected from the pass vote list for the consensus congress, and based on the first result value ([NODE₁, H₁]), NODE1 may recognize that it is selected for the consensus congress and that it becomes the chair.

NODE2 may confirm that [NODE₁, H₁], [NODE₀, H₀], [NODE₃, H₃], and [NODE₀, H₀₊₁] are selected from the pass vote list for the consensus congress and may confirm that the result value [NODE₂, H₂] corresponding to NODE2 itself is not included in the consensus congress. Here, NODE2 may recognize that NODE1 becomes the chair based on the first result value ([NODE₁, H₁]) on the pass vote list.

NODE3 may confirm that [NODE₁, H₁], [NODE₀, H₀], [NODE₃, H₃], and [NODE₀, H₀₊₁] are selected from the pass vote list for the consensus congress, confirm that the result value [NODE₃, H₃] corresponding to NODE3 itself is placed third on the pass vote list, and confirm that it is selected for the consensus congress. Here, NODE3 may recognize that NODE1 becomes the chair based on the first result value ([NODE₁, H₁]) on the pass vote list.

Because NODE1 is the chair, NODE1 receives confirm messages from the consensus congress nodes (NODE0, NODE1, and NODE3).

NODE0 and NODE3 confirm that they are included in the consensus congress although they are not the chair, so they send the confirm message to NODE1.

The chair forms a consensus committee by selecting part of the consensus congress, and in the example illustrated in FIG. 6, it can be seen that NODE1, NODE0, and NODE3 are selected as the consensus committee. Here, the result value [NODE₀, H₀₊₁] corresponding to the second public vote identifier (ID₀+1) of NODE0 is included in the consensus congress, but not in the consensus committee.

If the chair forms a consensus committee with NODE1, NODE0, and NODE3, as illustrated in FIG. 6, when the chair combines the public keys, it uses Pk₁₀₃, which is acquired by combining the public keys of NODE1, NODE0, and NODE3, to generate r₁₀₃ and provides r₁₀₃ to the consensus committee nodes.

If the chair forms a consensus committee by selecting [NODE₁, H₁], [NODE₀, H₀], and [NODE₀, H₀₊₁] from among the result values corresponding to the consensus congress, unlike that illustrated in FIG. 6, when the chair combines the public keys, it uses Pk₁₀, which is acquired by combining the public keys of NODE1 and NODE0, to generate r₁₀ and provides r₁₀ to the consensus committee nodes.

Therefore, the generated values of Pk and r vary depending on the composition of the consensus committee, so the consensus committee members generate sᵢ using the received r without knowing which member signs, and the chair cannot generate two multi-signatures at the same time.

However, it is necessary to inform the consensus committee nodes of the nodes belonging to the consensus committee (603) in order to verify whether the chair receives 2f+1 signatures and completes consensus. Here, because all nodes have a pass vote list (Pass_list), number 0 is assigned to the chair node, subsequent numbers are sequentially assigned according to indices on the pass vote list, and information about the composition of the consensus committee may be represented as a bitmap and then be delivered.

As illustrated in FIG. 6, the chair maintains the consensus committee on the pass vote list (Pass_list) in order to identify the consensus committee members that have signed (604).

When the multi-signature is completed, the block that has been agreed upon is delivered as a committed block. Here, the information about the composition of the consensus committee may be provided and used to identify the nodes that have signed on the pass vote list (Pass_list) (605).

Also, the nodes again generate a pass vote list (Pass_list) to form a consensus congress for the next block (Bₙ₊₂) by utilizing the received block.

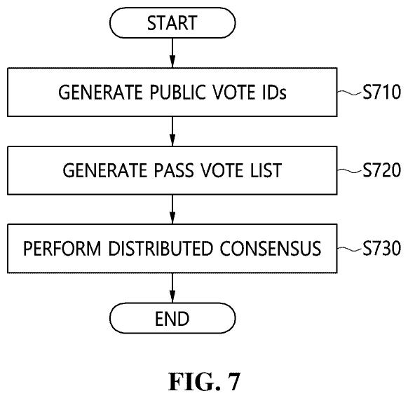

FIG. 7 is a flowchart illustrating an example of a distributed consensus method according to an embodiment of the present disclosure.

Referring to FIG. 7, in the distributed consensus method according to an embodiment of the present disclosure, public vote identifiers are generated using public node identifiers corresponding to nodes that constitute a blockchain at step S710.

Here, a number of public vote identifiers corresponding to the number of votes of each of the nodes may be generated for the node using the public node identifier corresponding to the node.

Here, the public vote identifiers may be generated by adding or subtracting one of generation values, including 0, to or from the public node identifier corresponding to each of the nodes.

Here, the public node identifiers may be public keys corresponding to the nodes.

Also, in the distributed consensus method according to an embodiment of the present disclosure, a pass vote list is generated by performing an operation corresponding to a success probability (p) for each of the public vote identifiers at step S720.

Here, the pass vote list may be generated in such a way that each of the nodes constituting the blockchain performs the operation for the nodes, including the node itself, based on the public vote identifiers. Here, the pass vote lists generated by the nodes constituting the blockchain at a specific time may be the same as each other.

Here, the operation may be to compare a random value generated using the public vote identifier and the previous block information with a threshold corresponding to the success probability.

Also, in the distributed consensus method according to an embodiment of the present disclosure, distributed consensus is performed based on at least part of consensus congress nodes corresponding to the pass vote list at step S730.

Here, the consensus congress nodes may be selected from among the nodes included in the pass vote list.

Here, the consensus on the previous block corresponding to the previous block information may be finally confirmed by a chair node selected from among the consensus congress nodes for the current block.

Here, the node with the largest or smallest value corresponding to the result of the operation, among the consensus congress nodes, may become the chair node.

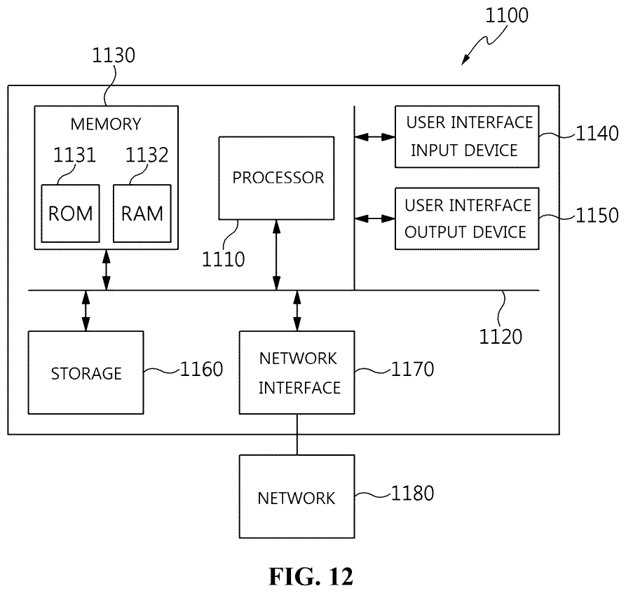

The distributed consensus method illustrated in FIG. 7 may be performed by a distributed consensus apparatus. The distributed consensus apparatus may be implemented with the configuration illustrated in FIG. 12.

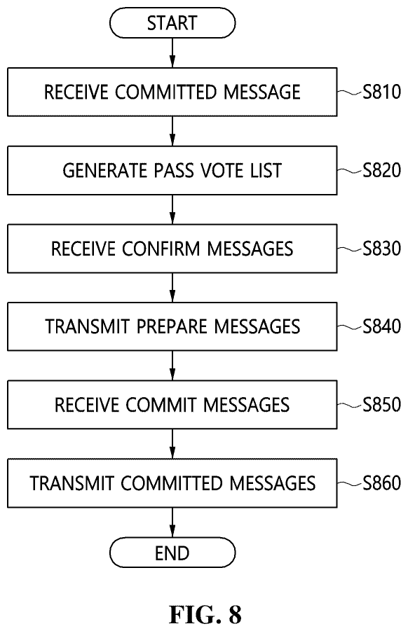

FIG. 8 is a flowchart illustrating an example of a blockchain generation method according to an embodiment of the present disclosure.

Referring to FIG. 8, in the blockchain generation method according to an embodiment of the present disclosure, a committed message corresponding to the previous block is received at step S810.

Also, in the blockchain generation method according to an embodiment of the present disclosure, a pass vote list is generated using information about the previous block and public vote identifiers at step S820.

Here, the pass vote list may be generated in such a way that each of nodes constituting the blockchain performs an operation corresponding to a success probability (p) for the nodes, including the node itself, based on the public vote identifiers. Here, the pass vote lists generated by the nodes constituting the blockchain at a specific time may be the same as each other.

Here, the operation may be to compare a random value generated using the public vote identifier and the information about the previous block with a threshold corresponding to the success probability.

Here, a number of public vote identifiers corresponding to the number of votes of each of the nodes may be generated for the node by using the public node identifier corresponding to the node.

Also, in the blockchain generation method according to an embodiment of the present disclosure, a chair node corresponding to the current block receives confirm messages from consensus congress nodes corresponding to the pass vote list and finally confirms the consensus result for the previous block based on the confirm messages at step S830. Here, the chair node may be recognized based on the pass vote list.

Also, in the blockchain generation method according to an embodiment of the present disclosure, the chair node transmits a prepare message for connecting the current block to the blockchain to consensus committee nodes selected from among the consensus congress nodes at step S840.

Also, in the blockchain generation method according to an embodiment of the present disclosure, the chair node receives commit messages from the consensus committee nodes at step S850.

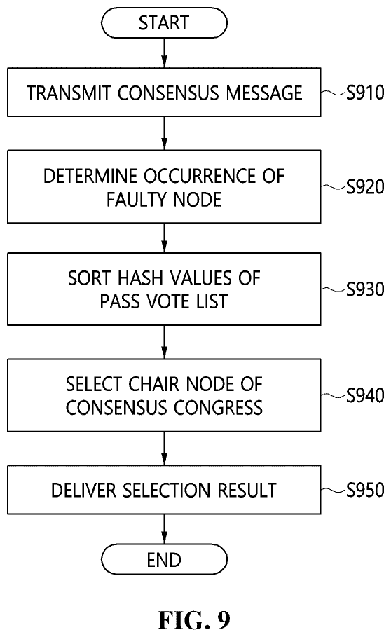

Also, in the blockchain generation method according to an embodiment of the present disclosure, the chair node transmits a committed message corresponding to the current block to all nodes at step S860. FIG. 9 is a flowchart illustrating a method for selecting a consensus congress chair in blockchain distributed consensus according to an embodiment of the present disclosure.

Referring to FIG. 9, in the method for selecting a consensus congress chair in blockchain distributed consensus according to an embodiment of the present disclosure, first, a consensus message may be transmitted at step S910.

That is, at step S910, distributed consensus may be performed in a blockchain.

Here, at step S910, a chair node of a consensus congress is selected according to the distributed consensus method described above with reference to FIGS. 1 to 8, and consensus congress nodes may perform distributed consensus.

Here, at step S910, the chair node of the consensus congress transmits a consensus message for distributed consensus of the blockchain to participating nodes, and the participating nodes may receive the consensus message from the chair node of the consensus congress for the distributed consensus of the blockchain.

Here, at step S910, the chair node of the consensus congress for the current block may include information about a recognized faulty node in the consensus message to propagate the same.

Here, at step S910, all nodes may share the same faulty node state.

Here, at step S910, the distributed consensus may proceed based on response messages of consensus committee nodes to the consensus message.

Here, at step S910, the distributed consensus may be performed using a protocol based on the Practical Byzantine Fault Tolerance (PBFT) described with reference to FIGS. 1 to 8.

Here, at step S910, the node assigned as order 0 is selected as the chair of the consensus congress, the remaining nodes are selected as consensus committee nodes, and then the distributed consensus may proceed.

Here, at step S910, the distributed consensus may proceed through the response messages to the consensus message.

Also, in the method for selecting a consensus congress chair in blockchain distributed consensus according to an embodiment of the present disclosure, the occurrence of a faulty node may be determined at step S920.

That is, at step S920, the chair of distributed consensus for a predetermined current block of the blockchain may determine a node identified as being disconnected from the network to be a faulty node.

Here, at step S920, the node that failed to transmit a response message due to the interruption of the network connection is determined to be a faulty node, and it may be excluded from the consensus process.

Also, in the method for selecting a consensus congress chair in blockchain distributed consensus according to an embodiment of the present disclosure, hash values of a pass vote list (pass_list) may be sorted at step S930.

That is, at step S930, the hash values inserted into the pass vote list used to select the chair node of the consensus congress may be sorted in consideration of the faulty node.

Here, at step S930, the chair node of the consensus congress for the previous block may generate a hash value by performing a hash operation on the header of the current block and IDᵢ when the distributed consensus is completed (IDᵢ indicating the public node identifier described above and indicating the ID values of the participating nodes, including the faulty node and the normal nodes).

Here, at step S930, if the result of the hash operation is less than the threshold that is derived from the node selection probability of p satisfying the conditions described in Equations (1) and (2) above, the hash value is inserted into the pass vote list (pass_list), and when the hash operations for all participating nodes are completed, the hash values in the pass vote list are sorted in ascending order, whereby consensus congress candidates for a new block may be generated.

Also, in the method for selecting a consensus congress chair in blockchain distributed consensus according to an embodiment of the present disclosure, the chair node of the consensus congress may be selected at step S940.

That is, at step S940, the chair node of the consensus congress for a new block may be selected based on the indices of the faulty node and normal nodes in the sorted pass vote list.

Here, at step S940, the chair node of the consensus congress for the current block may be selected based on the index of the first normal node, among the consensus congress candidates for the new block.

Here, at step S940, when a faulty node occurs, the chair of the consensus congress is replaced to prevent delay in consensus, and distributed consensus may proceed with normal nodes.

Here, at step S940, in order to minimize delay in consensus, the chair of the consensus congress may be replaced by delivering information about the first normal node.

Here, at step S940, when the new chair node of the consensus congress does not respond until a preset threshold time, a chair node of the consensus congress may be selected from among the remaining consensus committee nodes.

Here, at step S940, in order to select a normal node in the consensus congress as the chair node of the consensus congress, nodes with indices lower than the index of a normal node in the pass vote list, which is generated by performing a hash operation on a combination of the current block header value and the ID_list, are recognized as faulty nodes, and the faulty nodes may be adjusted to be placed further down the order in the consensus congress by adding a preset value to the hash values of the faulty nodes.

For example, at step S940, if the index sent by the chair of the consensus congress is 1, a large value is added to the node with the index (index 0) lower than index 1 such that the node is placed further down the order, whereby the node with index 1 may be selected as the chair of the consensus congress for the next block.

Also, at step S940, the node at the index of the first normal node indicated by the chair node of the current consensus congress may be set to be used as the chair node of the next consensus congress, without changing the order in the consensus congress.

For example, at step S940, when the chair for the current block notifies the nodes of index 1 at which the first normal node is located, all the nodes may select the node at index 1 in the consensus congress for the next block as the chair of the consensus congress and proceed with distributed consensus.

Also, in the method for selecting a consensus congress chair in blockchain distributed consensus according to an embodiment of the present disclosure, information about the selected chair node of the consensus congress may be delivered to all the participating nodes at step S950.

That is, at step S950, the chair node of the consensus congress for the next block may be recorded in the current block and delivered to all the participating nodes of the Here, at step S950, information about the faulty node may be transmitted to all the nodes.

For example, at step S950, when the chair node of the consensus congress for the current block includes information about the recognized faulty node in the consensus message and propagates the same, all the nodes may share the same faulty node state for the consensus for the next block.

Here, at step S950, nodes with indices lower than the index of a normal node in the pass vote list, which is generated by performing a hash operation on a combination of the current block header value and ID_list, may be determined to be faulty nodes.

Accordingly, only the chair may be changed while maintaining the order in the consensus congress.

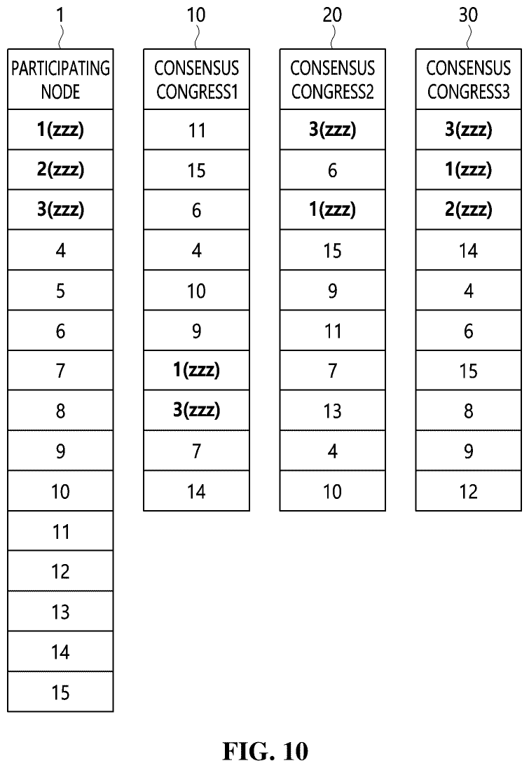

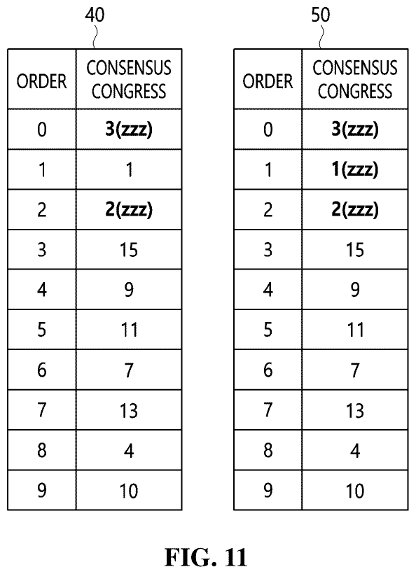

FIG. 10 is a view illustrating an ordered consensus congress including faulty nodes in a pass vote list according to an embodiment of the present disclosure. FIG. 11 is a view illustrating consensus congresses in the state in which nodes have inconsistent information about a faulty node in a pass vote list according to an embodiment of the present disclosure.

Referring to FIG. 10, an initial consensus congress 1 is described on the assumption that there are 15 participating nodes and up to 20% of the participating nodes can be Byzantine nodes. Because the participating nodes include up to three Byzantine nodes (15 nodes×0.2=3 nodes), the size of a consensus congress (3f+1) capable of tolerating three Byzantine nodes is ten nodes. Here, it is assumed that the chair node of the current consensus congress 1 recognizes three faulty nodes, which are node 1 (zzz), node 2 (zzz), and node 3 (zzz). Here, the faulty node is assumed to be a peer node, the network connection of which is disconnected from a specific node. Here, in a distributed environment such as a blockchain, the faulty nodes recognized by each node may not be identical until the faulty nodes are removed through consensus. As a result, if each node temporarily removes a faulty node from the consensus congress on its own, which may cause a problem in which the consensus congress differs among the nodes.

Referring to FIG. 11, it is assumed that some nodes determine that node 1 is not disconnected and thus select the consensus congress 40, while the other nodes select the consensus congress 50. In this case, the nodes that select the consensus congress 40 recognize node 1 as a chair, but the nodes that select the consensus congress 50 recognize node 15 as a chair, which may cause the problem of two separate consensus processes. In order to prevent this problem, it is necessary to use only a single consensus congress across the network. Therefore, in the present disclosure, a consensus congress for the next block is determined by including the faulty node states recognized by the chair node for the current block and delivering information thereabout, whereby the consensus congress information may be synchronized across all nodes. Although faulty nodes can be removed from the blockchain through consensus, a significant amount of time may be taken to reach consensus, so a method for minimizing the impact of a temporary faulty node on the next consensus is required.

The three consensus congresses 10, 20, and 30 illustrated in FIG. 10 are formed based on information about the faulty nodes recognized by the chair for the previous block, and the faulty nodes recognized by each node may differ. It is assumed that all nodes may form the same consensus congress by performing computation on their own, without exchanging messages related to consensus congress selection. Also, it is assumed that the nodes selected as the consensus congress are sorted in the same order because they are sorted according to their hash values in the computation process, and indices are assigned sequentially from 0 at the top. The method of forming a consensus congress that ensures the order of the nodes selected as the consensus congress without message exchange follows conventional technology. The present disclosure intends to provide a method of using only minimal data to share information about the operation states of nodes.

In the process for forming a consensus congress for the next block, if all nodes want to share the states of the nodes in order to share the state of a faulty node, the message complexity of O(n²) occurs. If the chair node for the current block provides faulty node information along with the block agreed upon when it propagates the block agreed upon in order to form a consensus congress for the next block, information about the faulty node may be shared through message exchange with the complexity of O(n), which may reduce the message complexity. In the present disclosure, the message size may be reduced by representing the node states provided by the chair node of the consensus congress.

In FIG. 10, it can be seen that consensus congress 1 (10), consensus congress 2 (20), and consensus congress 3 (30) represent examples of a randomly selected consensus congress for description. As a typical method for delivering the node state information of consensus congress 1 (10), there is a method of delivering the IDs of all faulty nodes, or a method of using a bitmap. For example, when a bitmap is used, a bitmap in which bit 0, bit 1, . . . , bit 9 are used for node 11, node 15, . . . , node 14 according to the order in consensus congress 1 (10) is used, and the bitmap is encoded by assigning 1 or 0 to each bit depending on whether the bit corresponds to a normal node or a faulty node. As a result, the states of all the nodes are encoded into ten bits of information, 1111110011, and may then be shared with the nodes. However, this method has a disadvantage in which the amount of data to be transmitted increases with an increase in the number of participating nodes. For example, according to the method for forming a consensus congress proposed in the present disclosure, when there are 50,000 participating nodes, the size of a consensus congress is 1,354, and more than 1,000 bits are required for encoding. Alternatively, if the number of faulty nodes is small, delivering the IDs of non-operational nodes may be a better method for sharing node states with less data. However, when the number of faulty nodes is large, the amount of data to be delivered increases in proportion to the number of faulty nodes, so this method may not be a good alternative.

The present disclosure intends to use consensus characteristics to deliver node information. For example, when the consensus congresses in FIG. 10 are assumed to use PBFT-based consensus, node at index 0 becomes the chair of the consensus congress, and the remaining nodes act as members to proceed with consensus.

Here, the chair of the consensus congress delivers a consensus message to the remaining members, and the members that receive the consensus message deliver messages related to consensus to the chair, whereby the consensus may proceed.

When the chair node of the consensus congress fails to respond in the consensus process, all the member nodes wait for a threshold time. Then, the remining member nodes may select a new chair and proceed with the consensus again.

When a fault occurs in any of the member nodes, the corresponding node cannot send a response message to the message sent by the chair of the consensus congress, so the chair may proceed with consensus with the remaining member nodes excluding the corresponding node. Therefore, it can be seen that the role of the chair of the consensus congress is the most important in proceeding with consensus. When a fault occurs in any of the member nodes, the chair node can exclude the faulty node from consensus in the consensus process, as described above, so the relative importance of member nodes may be regarded as lower.

In the present disclosure, information on the normal node with the minimum index in the ordered consensus congress may be delivered.

For example, consensus congress 1 (10) includes faulty nodes, which are node 1 (zzz) and node 3 (zzz). When node 11 at index 0 in consensus congress 1 (10), which is the chair node of the consensus congress, exchange consensus messages with the remaining member nodes, the faulty nodes, that is, node 1 (zzz) and node 3 (zzz), will not be able to respond to the chair node and thus be naturally excluded from the consensus.

Accordingly, if the fact that the first node, among the normal nodes recognized by the current consensus congress chair, is index 0 is shared, it is highly likely that normal consensus will proceed even if some of the member nodes fail. Of course, when a fault occurs in a node during the consensus process, a re-consensus protocol operates, whereby the consensus may be completed normally.

In the case of consensus congress 2 (20), the consensus congress including faulty nodes recognized by the current consensus congress chair, which are node 3 (zzz) and node 1 (zzz), is selected. Here, if the chair of the consensus congress for the current block does not share the state of node 3 (zzz) corresponding to the faulty node, node 3 (zzz) that becomes the chair of the consensus congress for the next block cannot deliver a message to the member nodes, so the member nodes wait for a certain time and then replace the chair according to the re-consensus protocol, thereby proceeding with normal consensus.

However, a consensus delay occurs in this process. If node 6, which follows node 3 (zzz) corresponding to the faulty node, is made to serve as the chair because it is a normal node, the delay caused by the replacement of the chair may be prevented during the consensus process. If the chair node of the consensus congress for the current block shares the normal node, node 6 at index 1 corresponding to the minimum index, with other nodes in order to share the state of the consensus congress, node 3 (zzz) that is a non-operating node is prevented from becoming the chair, whereby the consensus delay caused by the replacement of the chair may be prevented.

The present disclosure may be used to select node 6 as a new chair in the sorted consensus congress including faulty nodes in consensus congress 2 (20) by employing the following two methods.

The first method is a method of designating the node at index 0 in the consensus congress as the chair in all cases. To this end, all nodes with indices lower than the index of the first normal node sent by the chair are recognized as faulty nodes, and a large number is added to the faulty nodes' hash values stored in the computed pass vote list such that the faulty nodes are placed further down the order in the sorted consensus congress, whereby the order in the consensus congress is directly changed.

For example, in consensus congress 2 (20), when index 1 sent by the current chair is received, a large number is added to the hash values of nodes with indices lower than index 1 (i.e., index 0) stored in the pass vote list such that the nodes are placed further down the order in the consensus congress, whereby node 6 may become the chair of the consensus congress for the next block.

In the case of consensus congress 3 (30), if index 3 at which the first normal node is located is shared, the three nodes with indies lower than 3 (indices 0, 1, and 2) may be moved further down the order in the consensus congress such that node 14 becomes the chair for the next block.

The second method is to use the node at the index indicated by the current chair node as the chair of the next consensus congress, without changing the order in the consensus congress. For example, when index 1 at which the first normal node is located in consensus congress 2 (20) is provided, all nodes select the node at index 1 in the consensus congress as the chair, whereby all the nodes may select node 6 as the chair of the consensus congress and proceed with consensus. This method has the characteristic of being able to change the chair of the consensus congress without adjusting the order in the consensus congress.

In the case of consensus congress 3 (30), node 3 (zzz), node 1 (zzz), and node 2 (zzz) are all in a faulty state, and node 14 at index 3 is the first normal node in the sorted consensus congress. Therefore, when index 3 is sent to all the nodes, the fact that the chair of the corresponding consensus congress is node 14 may be shared through one of the two methods presented above.

Generally, in a PBFT-based distributed consensus with a consensus congress size of 3f+1, if more than f nodes shut down, consensus becomes impossible. That is, if the (f+1)-th node does not operate normally, consensus becomes impossible. Therefore, in the worst case, if the (f+1)-th node operates normally, nodes recognize that a consensus congress that enables consensus is present. In the present disclosure, when 50,000 nodes participate in consensus, 1,354 nodes may be selected as a consensus congress to form a consensus congress capable of tolerating Byzantine fault, and in this case, the number of Byzantine nodes, f, is 451, so faulty node information that can minimize consensus delay may be shared using only nine bits of data.

FIG. 12 is a view illustrating a computer system according to an embodiment of the present disclosure.

Referring to FIG. 12, the apparatus for selecting a consensus congress chair in blockchain distributed consensus according to an embodiment of the present disclosure may be implemented in a computer system 1100 including a computer-readable recording medium. As illustrated in FIG. 12, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for selecting a consensus congress chair in blockchain distributed consensus according to an embodiment of the present disclosure includes one or more processors 1110 and memory 1130 for storing at least one program executed by the one or more processors 1110, and the at least one program determines a node identified as being disconnected from a network connection with a chair node to be a faulty node in a distributed consensus process for a predetermined current block of a blockchain, sorts hash values inserted into a pass vote list used for selecting a chair node of a consensus congress for a subsequent block in consideration of the faulty node, selects a node at the top of the pass vote list in which the hash values are sorted as the chair node of the consensus congress for the subsequent block, records the index of the chair node of the consensus congress for the subsequent block in the current block, and delivers the same to all participating nodes of the blockchain.

Here, the pass vote list may be generated using information about a previous block and a public vote identifier corresponding to each of the nodes that constitute the blockchain.

Here, the pass vote list is generated in such a way that each of the nodes performs an operation corresponding to a success probability (p) for the nodes, including the corresponding node itself, based on the public vote identifiers, and the pass vote lists that the nodes constituting the blockchain generate for the same block may be identical to each other.

Here, the at least one program may determine nodes located at indices lower than the index of a normal node in the pass vote list to be faulty nodes, the pass vote list being generated by performing a hash operation on a combination of the header value of the current block and the public node identifiers stored in a vote identifier list.

Here, the at least one program may adjust the faulty node to be located further down the order in the consensus congress for the block by adding a preset value to the hash value of the faulty node stored in the pass vote list, and may select the node adjusted to be placed at the top as a new consensus congress chair node.

Here, the at least one program may allow the chair node of the consensus congress to select the node at the index at which the first normal node is located as a new consensus congress chair node.

Here, when the new consensus congress chair node does not respond until a preset threshold time, the at least one program may select a consensus congress chair node from among the remaining consensus congress member nodes.

Here, the at least one program may generate public vote identifiers using the public node identifiers corresponding to the nodes constituting the blockchain, generate a pass vote list by performing an operation corresponding to the success probability (p) for each of the public vote identifiers, and perform distributed consensus based on at least part of the consensus congress nodes corresponding to the pass vote list.

Here, the pass vote list may be generated in such a way that each of the nodes constituting the blockchain performs the operation for the nodes, including the corresponding node itself, based on the public vote identifiers. Here, the pass vote lists generated by the nodes constituting the blockchain at a specific time may be identical to each other.

Here, the operation may be to compare a random value generated using the public vote identifier and previous block information with a threshold corresponding to the success probability.

Here, a number of public vote identifiers corresponding to the number of votes of each of the nodes may be generated for the node by using the public node identifier corresponding to the node.

Here, the consensus congress nodes may be selected from among the nodes included in the pass vote list.

Here, consensus on the previous block corresponding to the previous block information may be finally confirmed by the chair node selected from among the consensus congress nodes for the current block.

Here, the public vote identifiers may be generated by adding or subtracting one of generation values, including 0, to or from the public node identifier corresponding to each of the nodes.

Here, the public node identifiers may be public keys corresponding to the nodes.

Here, the node with the largest or smallest value corresponding to the result of the operation, among the consensus congress nodes, may become the chair node.

The present disclosure may improve performance by minimizing consensus delay caused by a faulty node in a randomly selected distributed consensus congress.

Also, the present disclosure may minimize delays that may occur when a faulty node is selected for a consensus congress before the faulty node is removed from participating nodes by sharing information about the fault of the node with all nodes.

As described above, the apparatus and method for selecting a consensus congress chair in blockchain distributed consensus according to the present disclosure are not limitedly applied to the configurations and operations of the above-described embodiments, but all or some of the embodiments may be selectively combined and configured, so the embodiments may be modified in various ways.

What is claimed is:

1. An apparatus for selecting a consensus congress chair in blockchain distributed consensus, comprising:
one or more processors; and
memory for storing at least one program executed by the one or more processors,
wherein the at least one program
determines a node identified as being disconnected from a network connection with a chair during a distributed consensus process of a predetermined current block of a blockchain to be a faulty node,
sorts hash values inserted into a pass vote list used for selecting a consensus congress chair node in consideration of the faulty node,
selects a node at a top of the pass vote list in which the hash values are sorted as a consensus congress chair node of a subsequent block, and
records an index of the consensus congress chair node of the subsequent block in the current block and delivers the current block to all participating nodes of the blockchain.

2. The apparatus of claim 1, wherein the pass vote list is generated using information about a previous block and a public vote identifier corresponding to each of nodes that constitute the blockchain.

3. The apparatus of claim 2, wherein
the pass vote list is generated in such a way that each of the nodes performs an operation corresponding to a success probability (p) for the nodes, including the corresponding node itself, based on public vote identifiers, and
pass vote lists that the nodes constituting the blockchain generate for an identical block are identical to be each other.

4. The apparatus of claim 1, wherein the at least one program determines nodes located at indices lower than an index of a normal node in the pass vote list to be faulty nodes, the pass vote list being generated by performing a hash operation on a combination of a header of the current block and public node identifiers stored in a vote identifier list.

5. The apparatus of claim 4, wherein the at least one program adjusts the faulty node to be placed further down in an order of a consensus congress in the block by adding a preset value to a hash value of the faulty node stored in the pass vote list and selects a node adjusted to be placed at the top as a new consensus congress chair node.

6. The apparatus of claim 1, wherein the at least one program allows the consensus congress chair node to select a node at an index at which a first normal node is located in the sorted pass vote list as a new consensus congress chair node.

7. The apparatus of claim 6, wherein, when the new consensus congress chair node does not respond until a preset threshold time, the at least one program selects a consensus congress chair node from among remaining consensus congress member nodes.

8. A method for selecting a consensus congress chair in blockchain distributed consensus, performed by an apparatus for selecting a consensus congress chair in blockchain distributed consensus, comprising:
determining a node identified as being disconnected from a network connection with a consensus congress chair for distributed consensus of a predetermined current block of a blockchain to be a faulty node;
sorting hash values inserted into a pass vote list used for selecting a consensus congress chair node in consideration of the faulty node;
selecting a node at a top of the pass vote list in which the hash values are sorted as a consensus congress chair node for a subsequent block; and
recording the consensus congress chair node for the subsequent block in the current block and delivering the current block to all participating nodes of the blockchain.

9. The method of claim 8, wherein the pass vote list is generated using information about a previous block and a public vote identifier corresponding to each of nodes that constitute the blockchain.

10. The method of claim 9, wherein
the pass vote list is generated in such a way that each of the nodes performs an operation corresponding to a success probability (p) for the nodes, including the corresponding node itself, based on public vote identifiers, and
pass vote lists that the nodes constituting the blockchain generate for an identical block are identical to be each other.

11. The method of claim 8, wherein determining the node identified as being disconnected from the network connection with the consensus congress chair to be a faulty node comprises determining nodes located at indices lower than an index of a normal node in the pass vote list to be faulty nodes, the pass vote list being generated by performing a hash operation on a combination of a header of the current block and public node identifiers stored in a vote identifier list.

12. The method of claim 11, wherein selecting the node at the top of the pass vote list comprises
adjusting the faulty node to be placed further down in an order of a consensus congress in the block by adding a preset value to a hash value of the faulty node stored in the pass vote list, and
selecting a node adjusted to be placed at the top as a new consensus congress chair node.

13. The method of claim 8, wherein selecting the node at the top of the pass vote list comprises selecting, by the consensus congress chair node, a node located at an index at which a first normal node is located as a new consensus congress chair node.

14. The method of claim 13, wherein selecting the node at the top of the pass vote list comprises, when the new consensus congress chair node does not respond until a preset threshold time, selecting a consensus congress chair node from among remaining consensus congress member nodes.
